(19) United States
(12) Patent Application Publication
(10) Pub. No.: US 2015/0332150 A1
(43) Pub. Date: Nov. 19, 2015

(54) METHOD TO DETERMINE RELAY WIRING REQUIRED

(71) Applicant: Carrier Corporation, Farmington, CT (US)

(72) Inventor: Brian Carl Thompson, Fort Wayne, IN (US)

(21) Appl. No.: 14/693,411

(22) Filed: Apr. 22, 2015

Related U.S. Application Data
(60) Provisional application No. 61/992,628, filed on May 13, 2014.

(51) Int. Cl. G06N 5/04; F24F 11/02

(52) U.S. Cl. CPC G06N 5/04; F24F 11/02

(57) ABSTRACT

A method of determining a wiring configuration for one or more HVAC components operably coupled to one another and operably coupled to a main system controller comprising a processor and a display is provided. The method includes prompting a user with the processor to define the one or more HVAC components being installed; and determining with the processor the wiring configuration required for the one or more HVAC components defined. A wiring diagram is displayed on a display that corresponds to the wiring configuration required.

### CROSS REFERENCE TO RELATED APPLICATIONS

The present application is related to, and claims the priority benefit of, U.S. Provisional Patent Application Ser. No. 61/992,628 filed May 13, 2014, the contents of which are hereby incorporated in their entirety into the present disclosure.

### TECHNICAL FIELD OF THE DISCLOSED EMBODIMENTS

The presently disclosed embodiments generally relate to heating, ventilation, and air-conditioning (HVAC) systems, and more particularly, to a method of determining relay wiring in an HVAC system.

### BACKGROUND OF THE DISCLOSED EMBODIMENTS

Currently, non-communicating thermostats offer sets of relays used to wire up different HVAC equipment. In addition, a large number of pages in the installation manual are used to show the wiring diagrams for the various combinations of HVAC equipment available. The installer has to figure out which diagram is appropriate for the current configuration and then follow that diagram when wiring up the HVAC equipment. This is an error prone process that requires large manuals.

### SUMMARY OF THE DISCLOSED EMBODIMENTS

In at least one embodiment, a method of determining a wiring configuration for one or more HVAC components operably coupled to one another and operably coupled to a main system controller comprising a processor and a display is provided. The method includes prompting a user with the processor to define the one or more HVAC components being installed; and determining with the processor the wiring configuration required for the one or more HVAC components defined. A wiring diagram is displayed on a display that corresponds to the wiring configuration required

In at least one embodiment, a method of determining a wiring configuration for one or more HVAC components operably coupled to one another and operably coupled to a main system controller including a processor and a display is provided. The method includes prompting a user to define on the display of the main system controller the one or more HVAC components being installed; and receiving input from the user through an interface on the display. The input is indicative of the one or more HVAC components being installed. The processor determines the wiring configuration required for the one or more HVAC components defined. The display displays a wiring diagram that corresponds to the wiring configuration required.

In at least one embodiment, a device for determining a wiring configuration for one or more HVAC components operably coupled to one another is provided. The device includes a processor in communication with an input device. The input device is configured to receive input from a user that defines one or more HVAC components being installed. The processor determines the wiring configuration required for the one or more HVAC components defined. A display is provided in communication with the processor. The display is configured to display a wiring diagram that corresponds to the wiring configuration required.

In at least one embodiment, an HVAC communicating device is provided including a receiver to wirelessly receive device data from a plurality of HVAC components. The data includes device identification information. A memory is provided to store a plurality of wiring diagrams to assist in connecting HVAC components. A processor is provided to determine a preferred at least one of the plurality of wiring diagrams based on the received device identification information.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic component diagram of a controller in accordance with at least one embodiment.

FIG. 2 is a view of a display screen in accordance with at least one embodiment.

FIG. 3 is a view of a display screen in accordance with at least one embodiment.

FIG. 4 is a view of a display screen in accordance with at least one embodiment.

FIG. 5 is a schematic diagram of a method in accordance with at least one embodiment.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

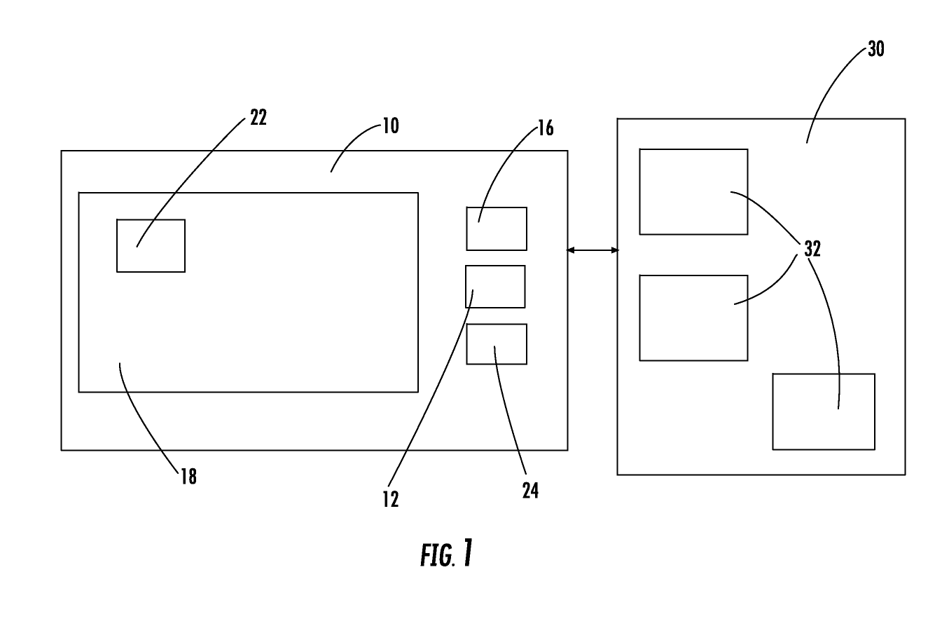

FIG. 1 is a schematic view of an embodiment of a device 10, for example a main system controller, for determining a wiring configuration for one or more HVAC components 32 operably coupled to one another within an HVAC system 30. It will be appreciated that the device 10 may include a computer, mobile device, thermostat, etc. to name a few non-limiting examples. In at least one embodiment, the device 10 is portable. The device 10 may include an axillary power supply 24, for example a battery. In at least one embodiment, the device 10 includes a processor 12 and at least one communication interface 16. The at least one communication interface 16 is configured to allow access to a network that communicates with the HVAC system 30. In at least one embodiment, the at least one communication interface 16 may be a wired or wireless connection.

In at least one embodiment, the device 10 further includes a display 18, for example a liquid crystal display (LCD) to name one non-limiting example, and an input device 22, wherein the input device 22 may include an interface on the display 18 to prompt the user for an input that defines the one or more HVAC components 32 being installed. The processor 12 is in communication with the input device 22. In at least one embodiment, the input device 22 is configured to receive input from a user that defines the one or more HVAC components 32 being installed. The processor 12 determines the wiring configuration required for the one or more HVAC components 32 defined. The display 18 is in communication with the processor 12 and is configured to display a wiring diagram that corresponds to the wiring configuration required.

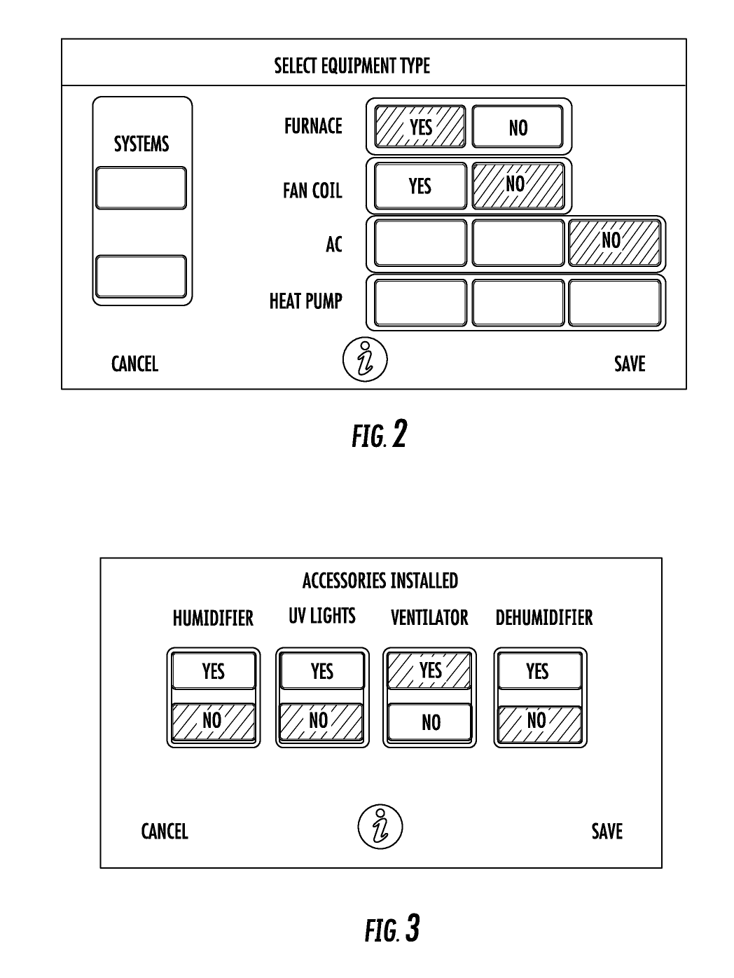

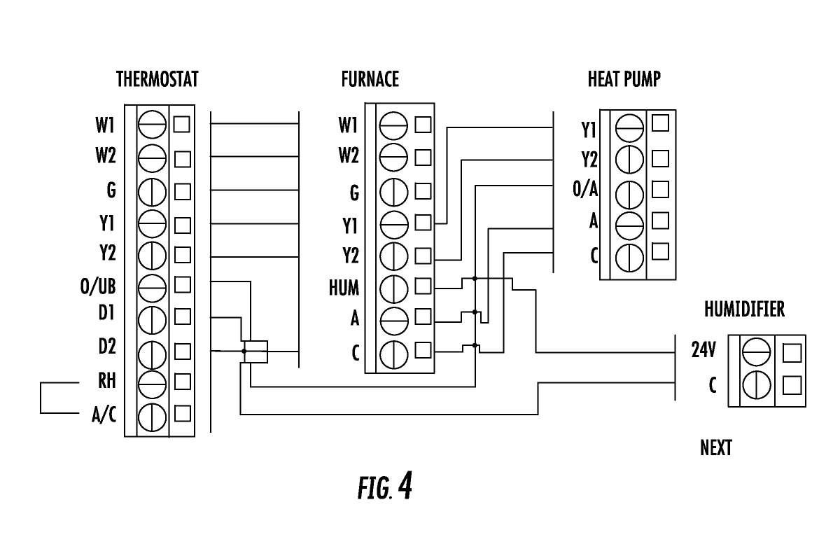

In a method 100 of determining a wiring configuration for the one or more HVAC components 32, as shown in FIG. 5, a user is prompted, at step 102, to define with the input device 22 the one or more HVAC components 32 being installed. For example, as shown in FIG. 2, the user is prompted to input whether the HVAC system 30 is a heat only or cool only system. For more complex systems, the user may be prompted to input whether the HVAC components 32 include a furnace, a fan coil, a one stage air conditioner, a two stage air conditioner, a one stage heat pump, and/or a two stage heat pump. Additionally, a second screen, as shown in FIG. 3 may prompt the user to input any accessories being installed, for example a humidifier, UV lights, a ventilator, and/or a dehumidifier.

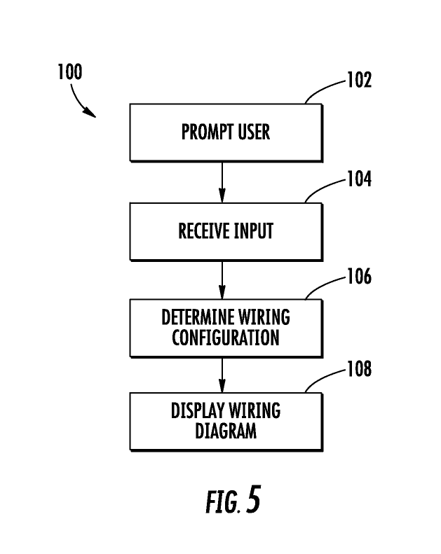

The device 10 receives the input, at step 104, from the user through the interface on the display 18. In the illustrated embodiment, the user operates the interface by contacting a touch screen display. Alternatively, the inputs may be entered using a keyboard, mouse, or the like. Based on the input, the processor 12 determines, at step 106, the wiring configuration required for the one or more HVAC components 32 defined. At step 108, the wiring diagram that corresponds to the wiring configuration required is displayed on the display 18, as shown in FIG. 4. In one embodiment, the processor 12 updates the wiring configuration required for the one or more HVAC components 32 defined. For example, as new wiring configurations are developed for new HVAC components 32, the processor 12, through the communication interface 16 downloads updated wiring configurations from the network. Additionally, the processor 12 may dynamically update the wiring diagram based on changes in the one or more HVAC components 32 defined. For example, a wiring diagram that includes a humidifier may be updated if the user determines not to include the humidifier in the HVAC system 30. In particular, through prompts on the display, the user updates the inputs so that a humidifier is not included in the system 30. Based on the updated prompts, the processor 12 dynamically determines and displays the updated wiring configuration.

It will therefore be appreciated that the present embodiments will save an installer time and also instruct the installer on the appropriate way to wire up the relays on the thermostat. In addition, costs will be saved on printed materials because of fewer pages required in the installation manual.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method of determining a wiring configuration for one or more HVAC components operably coupled to one another and operably coupled to a main system controller comprising a processor and a display, the method comprising:
prompting a user with the processor to define the one or more HVAC components being installed;
determining with the processor the wiring configuration required for the one or more HVAC components defined; and
displaying on the display a wiring diagram that corresponds to the wiring configuration required.

2. The method of claim 1 further comprising prompting the user to define the HVAC components being installed using an interface on the display.

3. The method of claim 1, wherein the main system controller comprises a thermostat.

4. The method of claim 1, wherein the main system controller is portable.

5. The method of claim 1 further comprising powering the main system controller with an auxiliary power supply.

6. The method of claim 1 further comprising displaying the wiring diagram on a mobile device display.

7. The method of claim 1 further comprising updating with the processor the wiring configuration required for the HVAC components defined.

8. The method of claim 1 further comprising dynamically updating the wiring diagram with the processor based on changes in the HVAC components defined.

9. A method of determining a wiring configuration for one or more HVAC components operably coupled to one another and operably coupled to a main system controller including a processor and a display, the method comprising:
prompting a user to define on the display of the main system controller the one or more HVAC components being installed;
receiving input from the user through an interface on the display, the input being indicative of the one or more HVAC components being installed;
determining with the processor the wiring configuration required for the one or more HVAC components defined; and
displaying on the display a wiring diagram that corresponds to the wiring configuration required.

10. The method of claim 9, wherein the main system controller comprises a thermostat.

11. The method of claim 9, wherein the main system controller is portable.

12. The method of claim 9 further comprising powering the main system controller with an auxiliary power supply.

13. The method of claim 9 further comprising updating with the processor the wiring configuration required for the one or more HVAC components defined.

14. The method of claim 9 further comprising dynamically updating the wiring diagram with the processor based on changes in the one or more HVAC components defined.

15. A device for determining a wiring configuration for one or more HVAC components operably coupled to one another, the device comprising:
a processor in communication with an input device, wherein the input device is configured to receive input from a user that defines one or more HVAC components being installed, the processor determining the wiring configuration required for the one or more HVAC components defined; and
a display in communication with the processor, wherein the display is configured to display a wiring diagram that corresponds to the wiring configuration required.

16. The device of claim 15 further comprising an interface on the display to prompt the user for the input that defines the equipment being installed.

17. The device of claim 15, wherein the device is at least one of a thermostat or a mobile device.

18. The device of claim 15 further comprising an auxiliary power supply.

19. The device of claim 15, wherein the processor updates the wiring configuration required for the one or more HVAC components defined.

20. The device of claim 15, wherein the processor dynamically updates the wiring diagram based on changes in the one or more HVAC components defined.

21. An HVAC communicating device comprising:
a receiver to wirelessly receive device data from a plurality of HVAC components, the data comprising device identification information;
a memory to store a plurality of wiring diagrams to assist in connecting HVAC components; and
a processor to determine a preferred at least one of the plurality of wiring diagrams based on the received device identification information.

22. The device of claim 21, further comprising a display to display the at least one preferred wiring diagram.

23. The device of claim 21, further comprising a wireless transmitter to transmit the at least one preferred wiring diagram to a display device.

24. The device of claim 21, wherein the receiver receives the device data via near field communication.
